(19) United States
(12) Patent Application Publication
(10) Pub. No.: US 2026/0219822 A1
(43) Pub. Date: Jul. 30, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Ryoto YABUSAKI, Kanagawa (JP)

(73) Assignee: FUJIFILM Business Innovation Corp., Tokyo (JP)

(21) Appl. No.: 19/312,515

(22) Filed: Aug. 28, 2025

(30) Foreign Application Priority Data
Jan. 30, 2025 (JP) 2025-014357

(51) Int. Cl. G06F 3/12

(52) U.S. Cl. CPC G06F 3/1257; G06F 3/1205; G06F 3/1254

(57) ABSTRACT

An information processing system includes a processor configured to: store, in a non-volatile storage unit, only a predetermined part of setting contents as preset information that is information on a preset function for presetting job contents; and when the preset function is used, automatically set other setting contents than the part of setting contents based on related information related to setting of the job contents.

### CROSS-REFERENCE TO RELATED APPLICATIONS

This application is based on and claims priority under 35 USC 119 from Japanese Patent Application No. 2025-014357 filed Jan. 30, 2025.

### BACKGROUND

### (i) Technical Field

The present disclosure relates to an information processing system, a non-transitory computer readable medium, and an information processing method.

### (ii) Related Art

Japanese Unexamined Patent Application Publication No. 2021-114680 discloses an image forming apparatus including a printer unit configured to perform printing, a scanner unit configured to read a document and generate image data, an operation panel configured to receive an operation performed by a user, and a display panel configured to perform display. The image forming apparatus includes a non-volatile storage unit that stores a plurality of applications for executing jobs, and a memory from which programs of the activated applications are read. The image forming apparatus further includes a controller configured to allocate a part of the storage area of the memory as an allocation area for each function to be used in a job to be executed. When the operation panel receives an activation operation for the application, the controller recognizes a function to be used by the application for which the activation operation has been performed, and recognizes a free space size that is a current size of a free space in the memory. The controller determines a required memory size of the memory that is required to execute a job of the application for which the activation operation has been performed, and causes the display panel to display a disablement target list when the free space size is smaller than the required memory size. The disablement target list is a list of unused functions that are not to be used by the application for which the activation operation has been performed and for which the allocation area is currently set in the memory. The operation panel receives a selection of a disablement function to be disabled from among the unused functions in the disablement target list, and the controller stops a process of the disablement function and releases the allocation area corresponding to the disablement function.

Japanese Unexamined Patent Application Publication No. 2021-125800 discloses an information processing apparatus that installs and executes an application that provides an extended function. The information processing apparatus includes an acquisition unit, a storage unit, a weighting unit, and a deletion unit. The acquisition unit acquires, from a server, a containerized application associated with a logged-in user or designated by the user. The storage unit stores the application acquired by the acquisition unit. The weighting unit weights the application stored in the storage unit based on the characteristics or usage of the application. When the user logs out, the deletion unit deletes the application stored in the storage unit based on the weighting.

### SUMMARY

Aspects of non-limiting embodiments of the present disclosure relate to an information processing system capable of increasing a free space of a non-volatile storage unit compared to a case where the non-volatile storage unit stores all pieces of information required to use a preset function for presetting job contents.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor configured to: store, in a non-volatile storage unit, only a predetermined part of setting contents as preset information that is information on a preset function for presetting job contents; and when the preset function is used, automatically set other setting contents than the part of setting contents based on related information related to setting of the job contents.

### BRIEF DESCRIPTION OF THE DRAWINGS

Exemplary embodiments of the present disclosure will be described in detail based on the following figures, wherein:

FIG. 1 is a block diagram illustrating a hardware configuration of an information processing system according to a first exemplary embodiment;

FIG. 2 is a block diagram illustrating an example of a functional configuration of the information processing system according to the first exemplary embodiment;

FIG. 3 illustrates an example of transition of display screens on a display unit in consumables saving copy as a first example of a preset function of the information processing system;

FIG. 4A illustrates an example of setting contents stored in a non-volatile memory for the consumables saving copy as the first example of the preset function of the information processing system;

FIG. 4B illustrates an example of setting contents stored in the non-volatile memory in a preset for the consumables saving copy according to a first comparative example;

FIG. 5 illustrates an example of transition of display screens on the display unit in high quality copy as a second example of the preset function of the information processing system;

FIG. 6A illustrates an example of setting contents stored in the non-volatile memory for the high quality copy as the second example of the preset function of the information processing system;

FIG. 6B illustrates an example of setting contents stored in the non-volatile memory in a preset for the high quality copy according to a second comparative example;

FIG. 7 illustrates an example of transition of display screens on the display unit in size saving scan as a third example of the preset function of the information processing system;

FIG. 8A illustrates an example of setting contents stored in the non-volatile memory for the size saving scan as the third example of the preset function of the information processing system;

FIG. 8B illustrates an example of setting contents stored in the non-volatile memory in a preset for the size saving scan according to a third comparative example;

FIG. 9 is a flowchart illustrating a flow of a process of registering the preset function of the information processing system;

FIG. 10 is a flowchart illustrating a flow of a process of using the preset function of the information processing system;

FIG. 11 is a block diagram illustrating an example of a functional configuration of an information processing system according to a first modification;

FIG. 12 illustrates a first example of a notification screen for notification about contents of automatic setting in the consumables saving copy as the first example of the preset function of the information processing system according to the first modification;

FIG. 13 illustrates a second example of the notification screen for notification about contents of automatic setting in the consumables saving copy as the first example of the preset function of an information processing system according to a second modification;

FIG. 14 illustrates an example of display screens of automatic setting in the preset for the consumables saving copy in an information processing system according to a fourth comparative example; and

FIG. 15 illustrates an example of setting contents stored in a non-volatile memory in an image forming apparatus according to a first comparative example.

### DETAILED DESCRIPTION

Hereinafter, exemplary embodiments of the present disclosure will be described with reference to the drawings. In the drawings, the same or equivalent components and parts are denoted by the same reference symbols. The dimensional ratios in the drawings are exaggerated for convenience of description and may be different from actual ratios.

### First Exemplary Embodiment

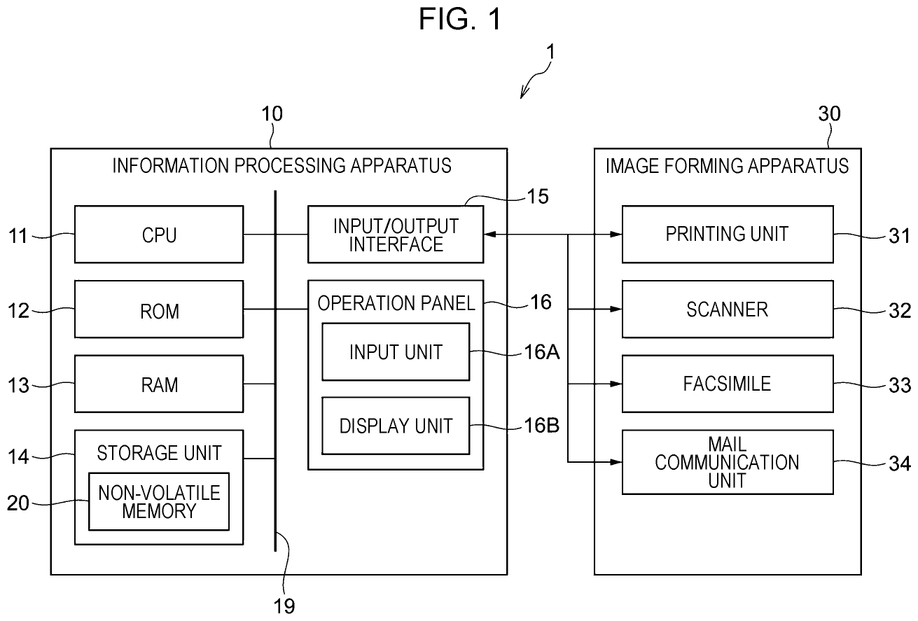

FIG. 1 is a block diagram illustrating a hardware configuration of an information processing system according to a first exemplary embodiment.

### Hardware Configuration of Information Processing System

As illustrated in FIG. 1, an information processing system 1 includes an information processing apparatus 10 and an image forming apparatus 30. For example, the information processing apparatus 10 and the image forming apparatus 30 are connected to each other by wire. The information processing apparatus 10 and the image forming apparatus 30 may be provided integrally with a housing of the information processing system 1 or may be provided separately from each other. Instead of this configuration, the information processing apparatus 10 and the image forming apparatus 30 may be connected to each other via a network by wire or by wireless.

The information processing apparatus 10 includes a central processing unit (CPU) 11, a read only memory (ROM) 12, a random access memory (RAM) 13, a storage unit 14, an input/output interface 15, and an operation panel 16. These components are communicatively connected to each other via a bus 19. The information processing apparatus 10 controls each part of the image forming apparatus 30.

The image forming apparatus 30 includes a printing unit 31, a scanner 32, a facsimile 33, and a mail communication unit 34. The hardware configuration of the information processing system 1 relates to the present disclosure, and the information processing system 1 may have another configuration.

The CPU 11 is a central processing unit, and executes various programs and controls each part. The CPU 11 is an example of a processor. That is, the CPU 11 reads a program from the ROM 12 and executes the program by using the RAM 13 as a work area. The CPU 11 performs control on the above components and various types of arithmetic processing based on the program recorded in the ROM 12. For example, the ROM 12 stores a registration processing program for registering a preset function and a use processing program for using (i.e., executing) the preset function. The preset function will be described later.

The ROM 12 stores various programs and various types of data. The RAM 13 temporarily stores a program or data as a work area. For example, the ROM 12 stores a program of a printer driver. The CPU 11 functions as the printer driver by reading the program of the printer driver from the ROM 12 and executing the program. Although illustration is omitted, the information processing apparatus 10 may include a storage. The storage is a hard disk drive (HDD) or a solid state drive (SSD). For example, the storage instead of the ROM 12 may store various programs including an operating system and various types of data.

The storage unit 14 includes a non-volatile memory 20 as an example of a non-volatile storage unit. The non-volatile memory is a type of semiconductor memory to be used to store data and includes a storage element that can retain stored contents without being supplied with electric power from the outside. Examples of the non-volatile memory include a flash memory to be used also as a computer storage. The non-volatile memory 20 stores, for example, a predetermined part of setting contents as information on the preset function. Although illustration is omitted, the storage unit 14 may include a volatile memory etc. in addition to the non-volatile memory 20.

The input/output interface 15 is an interface for transmitting and receiving information etc. to and from the components in the information processing system 1. For example, the input/output interface 15 is electrically connected to the printing unit 31, the scanner 32, the facsimile 33, and the mail communication unit 34. With this configuration, the CPU 11 controls the operations of the printing unit 31, the scanner 32, the facsimile 33, and the mail communication unit 34 via the input/output interface 15.

The operation panel 16 includes an input unit 16A and a display unit 16B. The input unit 16A receives various inputs such as a job instruction from a user. For example, a print instruction is input through the input unit 16A. The display unit 16B displays information. The display unit 16B is, for example, a liquid crystal display. A touch panel system is employed for the display unit 16B, and a part of the display unit 16B functions as the input unit 16A.

The printing unit 31 prints image data on a medium such as paper based on a print job. The printing unit 31 is an example of an image forming unit. For example, the printing unit 31 prints image data on a medium by an electrophotographic system. The printing unit 31 may print image data on a medium by an inkjet system instead of the electrophotographic system.

The scanner 32 optically reads a document and acquires image data. The scanner 32 is an example of a reading unit. For example, image data acquired by the scanner 32 may be printed on a medium by the printing unit 31.

The facsimile 33 electronically transmits and receives image data such as characters and graphics via a telephone line. For example, information such as image data acquired by the scanner 32 may be transmitted to another apparatus by the facsimile 33. The facsimile 33 is an example of a transmission unit.

The mail communication unit 34 transmits and receives data to and from another computer. The mail communication unit 34 transmits and receives data between computers connected to a network in accordance with communication protocol standards. For example, image data etc. acquired by the scanner 32 may be converted into data that can be communicated by mail, the data may be attached to mail by the mail communication unit 34, and the mail may be transmitted to another computer. In this case, the mail communication unit 34 is an example of the transmission unit.

### Configuration and Problem of Image Forming Apparatus of First Comparative Example

The configuration and problem of an image forming apparatus of a first comparative example will be described.

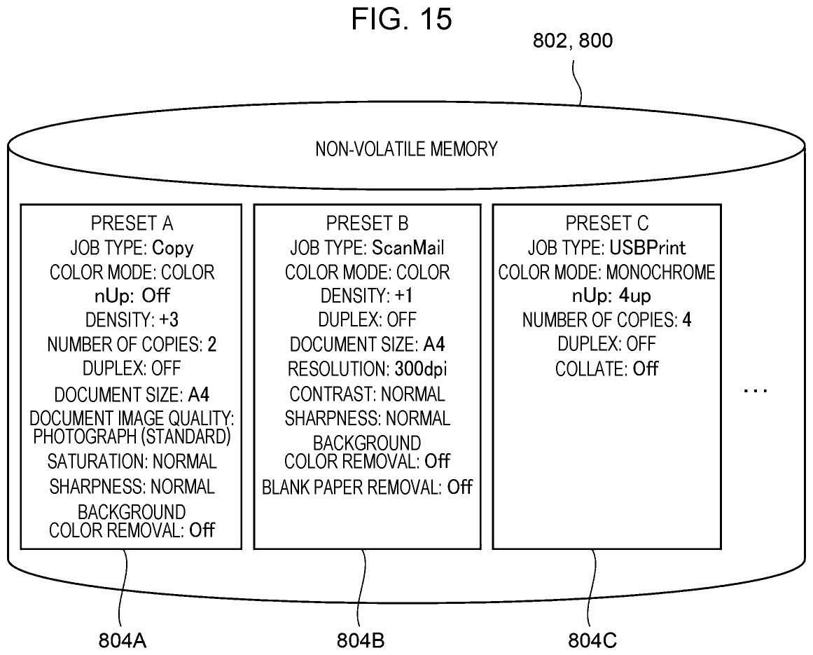

FIG. 15 illustrates an example of setting contents of a preset function stored in a non-volatile memory in the image forming apparatus according to the first comparative example. As illustrated in FIG. 15, an image forming apparatus 800 according to the first comparative example includes a non-volatile memory 802. The image forming apparatus 800 has a preset function for presetting the setting contents of each job such as copy or print. For example, setting contents 804A, 804B, and 804C of a plurality of preset functions are stored in the non-volatile memory 802. The setting values of the setting contents 804A, 804B, and 804C illustrated in FIG. 15 are merely examples.

For example, in emerging countries overseas, one image forming apparatus 800 may be used by 100 or more people. However, the image forming apparatus 800 cannot include a large-capacity non-volatile memory from the viewpoint of cost, and uses the non-volatile memory 802 having a general capacity. When a large number of people use one image forming apparatus 800, there are many setting contents for creating preset functions, and the memory consumption increases. Therefore, the setting contents of the preset functions for all the people cannot be stored in the non-volatile memory 802.

In the information processing system 1 according to the exemplary embodiment of the present disclosure, the free space of the non-volatile memory 20 is increased compared to a case where the non-volatile memory stores all pieces of information required to use the preset function for presetting job contents.

### Functional Configuration of Information Processing System

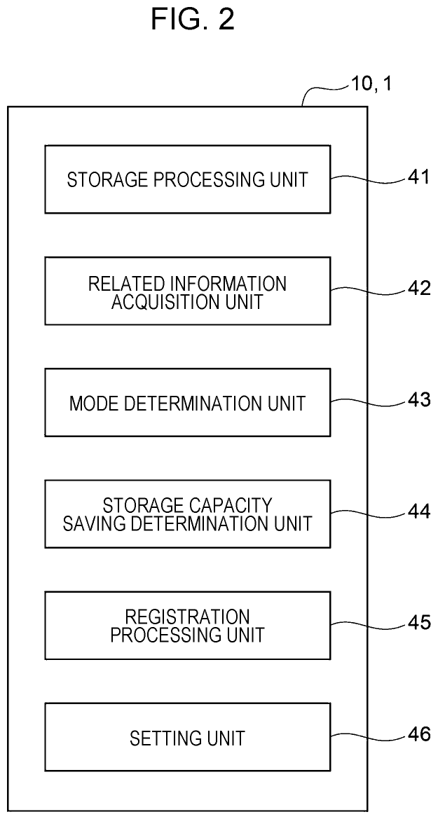

FIG. 2 is a block diagram illustrating an example of a functional configuration of the information processing apparatus 10 of the information processing system 1.

As illustrated in FIG. 2, the information processing apparatus 10 includes, as functional components, a storage processing unit 41, a related information acquisition unit 42, a mode determination unit 43, a storage capacity saving determination unit 44, a registration processing unit 45, and a setting unit 46. Each functional component is implemented by the CPU 11 reading an information processing program stored in the ROM 12, loading the program into the RAM 13, and executing the program.

The storage processing unit 41 performs a process of storing (i.e., writing) information in the non-volatile memory 20. The storage processing unit 41 performs a process of storing, in the non-volatile memory 20, only a predetermined part of setting contents as information on the preset function. The preset function is an example of a preset function for presetting job contents. That is, the storage processing unit 41 performs a process of storing only a predetermined part of setting contents as preset information in the non-volatile memory 20. Examples of the job include a printing process by the printing unit 31, a reading (i.e., scanning) process by the scanner 32, a communication process by the facsimile 33, and a mail communication process by the mail communication unit 34. The term “preset” as used herein refers to setting values adjusted in advance or combinations of setting values that are stored with identifiers or numbers.

The related information acquisition unit 42 acquires related information related to the setting of job contents. The related information includes, depending on the job contents, for example, information on settings that affect consumables, information on settings that affect high image quality, or information on settings that affect a data size. High image quality refers to image quality of an image to be printed on a medium that is higher than normal image quality. A part of the related information may be stored in the non-volatile memory 20.

The mode determination unit 43 determines a mode corresponding to job contents. For example, the mode determination unit 43 determines a mode based on related information related to the setting of job contents. Examples of the mode include a consumables saving mode, a high quality mode, and a low data size mode. For example, when the mode determination unit 43 determines that a user wants to “save consumables” based on the related information related to the setting of job contents, the mode determination unit 43 determines the “consumables saving mode.”

The storage capacity saving determination unit 44 determines whether the storage capacity of the non-volatile memory 20 is savable. For example, when the preset function is registered, the storage capacity saving determination unit 44 determines whether the storage capacity of the non-volatile memory 20 is savable based on mode information corresponding to the job contents.

The registration processing unit 45 performs various processes for registering the preset function. For example, when the preset function is registered and the storage capacity saving determination unit 44 determines that the storage capacity is savable, the registration processing unit 45 causes the display unit 16B to display a registration portion for saving. When the user selects the registration portion for saving, the storage processing unit 41 performs a process of storing only a predetermined part of setting contents as the preset function in the non-volatile memory 20. The “selection” of the registration portion for saving is a concept including determination.

When the storage capacity saving determination unit 44 determines that the storage capacity is not savable, the registration processing unit 45 causes the display unit 16B not to display the registration portion for saving.

When the preset function is used, the setting unit 46 automatically sets the setting contents other than the predetermined part of setting contents based on the related information. As described above, the non-volatile memory 20 stores only a predetermined part of setting contents as the information on the preset function. When the preset function is used, the setting unit 46 automatically sets (i.e., automatically determines) the other setting contents that are not stored in the non-volatile memory 20 based on the related information. The other setting contents include, for example, settings that affect consumables, settings that affect high image quality, or settings that affect reduction in data size. In the information processing system 1, the setting unit 46 automatically sets the setting contents that affect consumables when the preset function is used, without storing, for example, the settings that affect consumables as the preset in the non-volatile memory 20.

For example, when the preset function is used, the setting unit 46 automatically determines setting items associated with mode information for the setting contents other than the predetermined part of setting contents. The mode information is information on each mode determined by the mode determination unit 43.

### Examples of Processes on Preset Function by Information Processing System

Next, examples of processes on the preset function by the information processing system 1 will be described.

### First Example of Preset Function

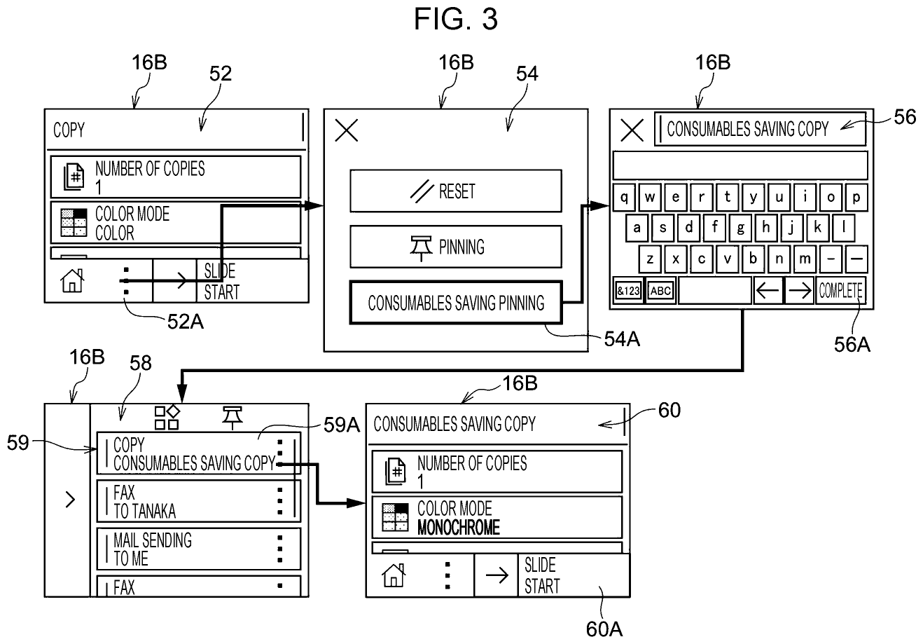

First, consumables saving copy that is a first example of the preset function of the information processing system 1 will be described. FIG. 3 illustrates an example of transition of display screens on the display unit 16B in the consumables saving copy.

When the information processing system 1 determines that the user wants to “save consumables,” the mode changes to the “consumables saving mode.” In the information processing system 1, the settings that affect consumables are automatically made when the preset function is used, without storing the settings as the preset in the non-volatile memory 20.

For example, when the paper quality setting of an output tray is “reused paper,” determination is made that the user wants to “save consumables,” and the mode changes to the “consumables saving mode.” The information indicating that the paper quality setting of the output tray is “reused paper” is an example of the related information related to the setting of job contents. The information indicating that the paper quality setting of the output tray is “reused paper” is prestored in the RAM 13 or the non-volatile memory 20 by a user's operation.

As illustrated in FIG. 3, an operation screen for a copy process is displayed on a display screen 52 of the display unit 16B. For example, when the user selects registration of the preset function (not illustrated) from a menu button 52A on the display screen 52, transition is made to a display screen 54. On the display screen 54, a menu selection screen is displayed, and a “consumables saving pinning” button 54A is displayed as a new menu. The “consumables saving pinning” button 54A is an example of the registration portion for saving.

When the user selects the “consumables saving pinning” button 54A on the display screen 54, transition is made to a display screen 56. On the display screen 56, for example, the user can input a function name, and the function name “consumables saving copy” is input. For example, a preset name “consumables saving copy” may be displayed and the user may change the name. When a completion button 56A is pressed on the display screen 56, transition is made to a display screen 58. Thus, the registration of the preset function is completed.

A plurality of job menus 59 is displayed on the display screen 58. When the user selects a “consumables saving copy” button 59A on the display screen 58, transition is made to a display screen 60 for executing the “consumables saving copy.” When the user presses or slides a start button 60A on the display screen 60, a copy process of the “consumables saving copy” is executed.

For the preset created by designating the “consumables saving pinning” button 54A on the display screen 54, the CPU 11 of the information processing apparatus 10 automatically makes the settings that affect consumables when the preset function is used, without storing the settings in the non-volatile memory 20. That is, when the preset function is used, the CPU 11 of the information processing apparatus 10 automatically sets an optimum setting value (e.g., a setting value determined by the information processing apparatus 10 to be capable of maximally saving consumables).

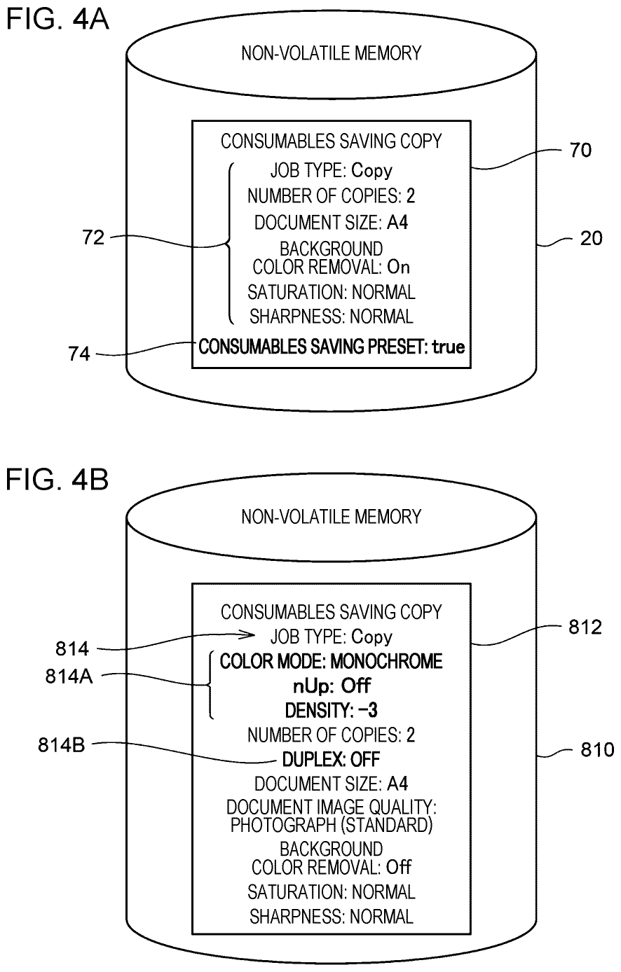

FIG. 4A illustrates an example of the setting contents stored in the non-volatile memory 20 for the consumables saving copy as the first example of the preset function of the information processing system 1. FIG. 4B illustrates an example of setting contents stored in the non-volatile memory in a preset for the consumables saving copy according to a first comparative example.

As illustrated in FIG. 4B, in the first comparative example, all setting contents 814 are stored in a non-volatile memory 810 as preset information 812 for the consumables saving copy.

In the information processing system 1, as illustrated in FIG. 4A, the settings that affect consumables are not stored in the non-volatile memory 20 as the preset for the consumables saving copy, but only a predetermined part of setting contents 72 is stored in the non-volatile memory 20 as preset information 70. For example, information 814A on a color mode, nUP, and density and information 814B on duplex printing in FIG. 4B are not stored in the non-volatile memory 20 as the settings that affect consumables. An information item 74 indicating that the consumables saving preset is applied is stored in the non-volatile memory 20. Thus, the amount of information stored in the non-volatile memory 20 is reduced, and the efficiency of the non-volatile memory 20 is improved.

When the preset function of the consumables saving copy is used, the CPU 11 of the information processing apparatus 10 automatically sets items that affect consumables based on related information related to consumables saving. For example, when the preset function of the consumables saving copy is used, the CPU 11 of the information processing apparatus 10 automatically determines setting items associated with the consumables saving mode (e.g., items related to information on the color mode, nUP, density, and duplex printing) for the items that affect consumables.

Examples of the conditions for changing to the “consumables saving mode” include the following cases in addition to the case where the paper quality setting of the output tray is “reused paper.” Examples of the conditions include a case where the operation is in a toner saving mode, a case where the operation is in a forced monochrome printing mode, a case where the operation is in a drum extension mode, and a case where the number of color prints is overwhelmingly smaller than the number of monochrome prints. The number of color prints is overwhelmingly smaller than the number of monochrome prints, for example, when the number of color prints is equal to or smaller than a predetermined threshold. These cases are examples of the related information related to the setting of job contents.

### Second Example of Preset Function

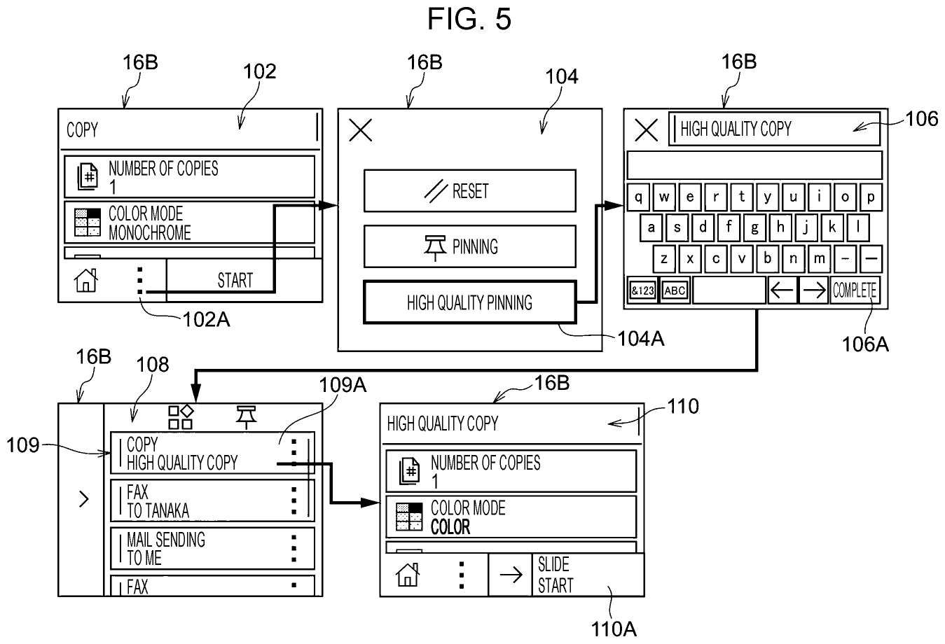

Next, high quality copy that is a second example of the preset function of the information processing system 1 will be described. FIG. 5 illustrates an example of transition of display screens on the display unit 16B in the high quality copy.

When the information processing system 1 determines that the user wants to “print with high quality,” the mode changes to the “high quality mode.” In the information processing system 1, the settings that affect high image quality are automatically made when the preset function is used, without storing the settings as the preset in the non-volatile memory 20.

For example, when the paper quality setting of the output tray is “high quality paper,” determination is made that the user wants to “print with high quality,” and the mode changes to the “high quality mode.” The information indicating that the paper quality is “high quality paper” is an example of the related information related to the setting of job contents. The information indicating that the paper quality is “high quality paper” is prestored in the RAM 13 or the non-volatile memory 20 by a user's operation.

As illustrated in FIG. 5, an operation screen for a copy process is displayed on a display screen 102 of the display unit 16B. For example, when the user selects registration of the preset function (not illustrated) from a menu button 102A on the display screen 102, transition is made to a display screen 104. On the display screen 104, a menu selection screen is displayed, and a “high quality pinning” button 104A is displayed as a new menu. The “high quality pinning” button 104A is an example of the registration portion for saving.

When the user selects the “high quality pinning” button 104A on the display screen 104, transition is made to a display screen 106. On the display screen 106, for example, the user can input a function name, and the function name “high quality copy” is input. For example, a preset name “high quality copy” may be displayed and the user may change the name. When a completion button 106A is pressed on the display screen 106, transition is made to a display screen 108. Thus, the registration of the preset function is completed.

A plurality of job menus 109 is displayed on the display screen 108. When the user selects a “high quality copy” button 109A on the display screen 108, transition is made to a display screen 110 for executing the “high quality copy.” For example, when the user presses or slides a start button 110A on the display screen 110, a copy process of the “high quality copy” is executed.

For the preset created by designating the “high quality pinning” button 104A on the display screen 104, the CPU 11 of the information processing apparatus 10 automatically makes the settings that affect high image quality when the preset function is used, without storing the settings in the non-volatile memory 20. That is, when the preset function is used, the CPU 11 of the information processing apparatus 10 automatically sets an optimum setting value (e.g., an optimum setting value determined by the information processing apparatus 10).

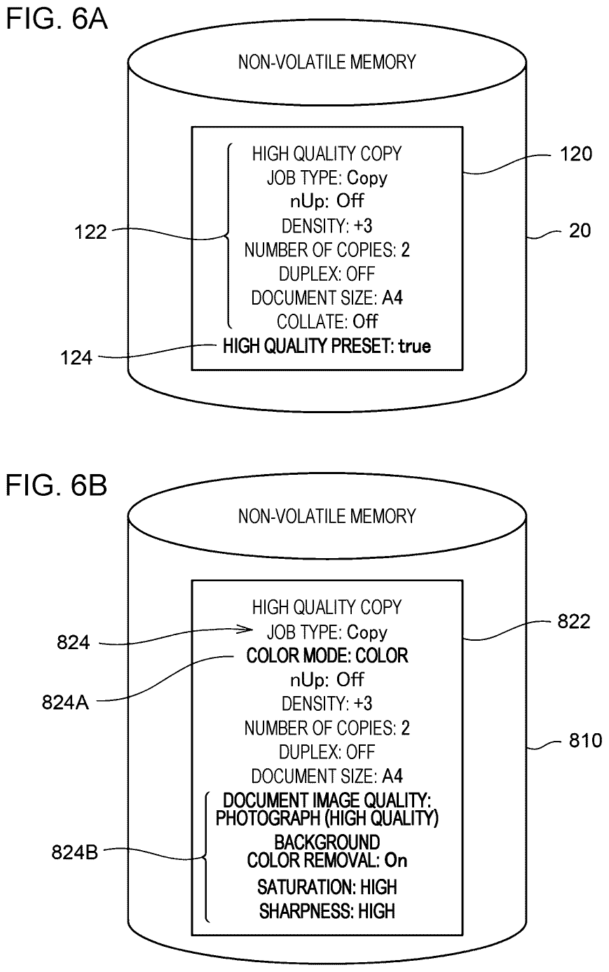

FIG. 6A illustrates an example of the setting contents stored in the non-volatile memory 20 for the high quality copy as the second example of the preset function of the information processing system 1. FIG. 6B illustrates an example of setting contents stored in the non-volatile memory in a preset for the high quality copy according to a second comparative example.

As illustrated in FIG. 6B, in the second comparative example, all setting contents 824 are stored in the non-volatile memory 810 as preset information 822 for the high quality copy.

In the information processing system 1, as illustrated in FIG. 6A, the settings that affect high image quality are not stored in the non-volatile memory 20 as the preset for the high quality copy, but only a predetermined part of setting contents 122 is stored in the non-volatile memory 20 as preset information 120. For example, information 824A on a color mode and information 824B on document image quality, background color removal, saturation, and sharpness in FIG. 6B are not stored in the non-volatile memory 20 as the settings that affect high image quality. An information item 124 indicating that the high quality preset is applied is stored in the non-volatile memory 20. Thus, the amount of information stored in the non-volatile memory 20 is reduced, and the efficiency of the non-volatile memory 20 is improved.

When the preset function of the high quality copy is used, the CPU 11 of the information processing apparatus 10 automatically sets items that affect high image quality based on related information related to high image quality. For example, when the preset function of the high quality copy is used, the CPU 11 of the information processing apparatus 10 automatically determines setting items associated with the high quality mode (e.g., items related to information on the color mode, document image quality, background color removal, saturation, and sharpness) for the items that affect high image quality.

Examples of the conditions for changing to the “high quality mode” include the following case in addition to the case where the paper quality setting of the output tray is “high quality paper.” Examples of the conditions include a case where the paper quality setting is “coated paper” and the “image quality setting of coated paper” is “priority on image quality.” These cases are examples of the related information related to the setting of job contents.

### Third Example of Preset Function

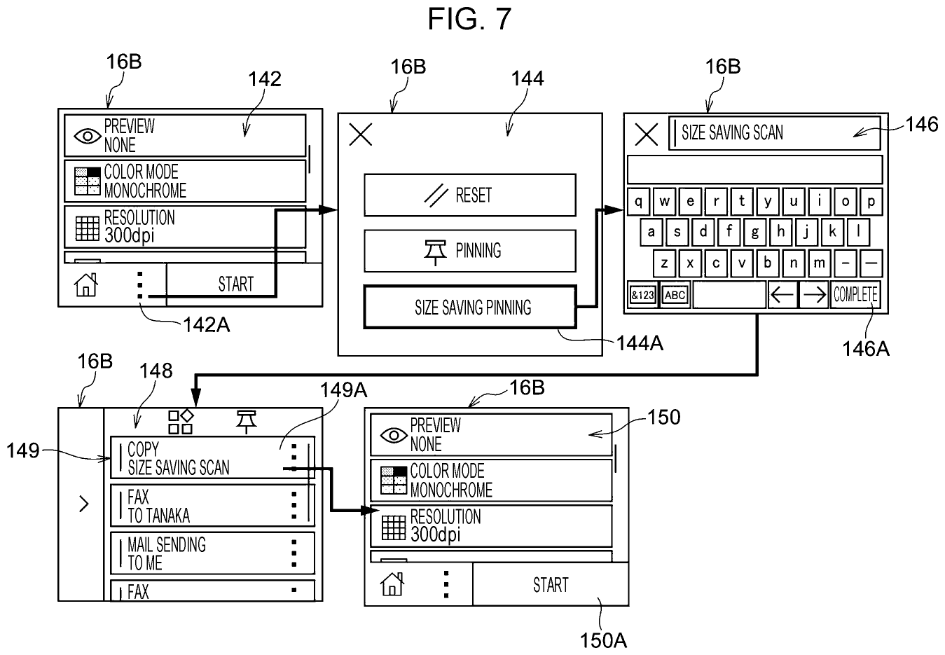

Next, size saving scan that is a third example of the preset function of the information processing system 1 will be described. FIG. 7 illustrates an example of transition of display screens on the display unit 16B in the size saving scan.

When the information processing system 1 determines that the user wants to “minimize the data size,” the mode changes to the “low data size mode.” In the information processing system 1, the settings that affect the data size are automatically made when the preset function is used, without storing the settings as the preset in the non-volatile memory 20.

For example, when the user intentionally sets the “maximum size of outgoing mail” in the mail setting to a small size, the mode changes to the “low data size mode.” For example, this corresponds to a case where the default setting of “4096 KB” is changed to “50 KB” during operation. The information indicating that the “maximum size of outgoing mail” in the mail setting is set to a small size is an example of the related information related to the setting of job contents.

As illustrated in FIG. 7, an operation screen for a scan process is displayed on a display screen 142 of the display unit 16B. For example, when the user selects registration of the preset function (not illustrated) from a menu button 142A on the display screen 142, transition is made to a display screen 144. On the display screen 144, a menu selection screen is displayed, and a “size saving pinning” button 144A is displayed as a new menu. The “size saving pinning” button 144A is an example of the registration portion for saving.

When the user selects the “size saving pinning” button 144A on the display screen 144, transition is made to a display screen 146. On the display screen 146, for example, the user can input a function name, and the function name “size saving scan” is input. For example, a preset name “size saving scan” may be displayed and the user may change the name. When a completion button 146A is pressed on the display screen 146, transition is made to a display screen 148. Thus, the registration of the preset function is completed.

A plurality of job menus 149 is displayed on the display screen 148. When the user selects a “size saving scan” button 149A on the display screen 148, transition is made to a display screen 150 for executing the “size saving scan.” For example, when the user presses a start button 150A on the display screen 150, a reading process and a copy process of the “size saving scan” are executed.

For the preset created by designating the “size saving pinning” button 144A on the display screen 144, the CPU 11 of the information processing apparatus 10 automatically makes the settings that affect the data size when the preset function is used, without storing the settings in the non-volatile memory 20. That is, when the preset function is used, the CPU 11 of the information processing apparatus 10 automatically sets an optimum setting value (e.g., an optimum setting value determined by the information processing apparatus 10).

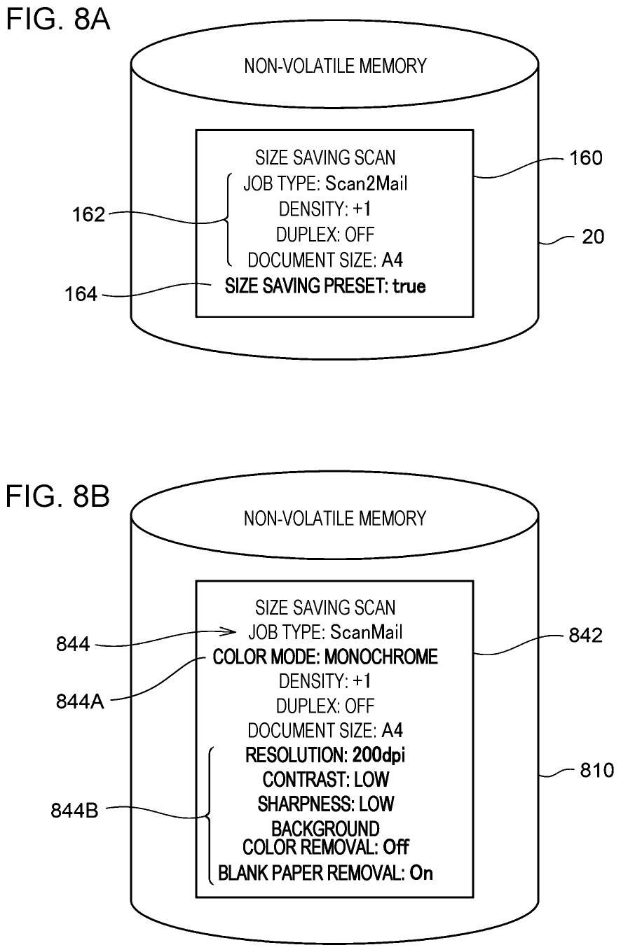

FIG. 8A illustrates an example of the setting contents stored in the non-volatile memory 20 for the size saving scan as the third example of the preset function of the information processing system 1. FIG. 8B illustrates an example of setting contents stored in the non-volatile memory in a preset for the size saving scan according to a third comparative example.

As illustrated in FIG. 8B, in the third comparative example, all setting contents 844 are stored in the non-volatile memory 810 as preset information 842 for the size saving scan.

In the information processing system 1, as illustrated in FIG. 8A, the settings that affect the data size are not stored in the non-volatile memory 20 as the preset for the size saving scan, but only a predetermined part of setting contents 162 is stored in the non-volatile memory 20 as preset information 160. For example, information 844A on a color mode and information 844B on resolution, contrast, sharpness, background color removal, and blank paper removal in FIG. 8B are not stored in the non-volatile memory 20 as the settings that affect the data size. An information item 164 indicating that the size saving preset is applied is stored in the non-volatile memory 20. Thus, the amount of information stored in the non-volatile memory 20 is reduced, and the efficiency of the non-volatile memory 20 is improved.

When the preset function of the size saving scan is used, the CPU 11 of the information processing apparatus 10 automatically sets items that affect the data size based on related information related to the data size. For example, when the preset function of the size saving scan is used, the CPU 11 of the information processing apparatus 10 automatically determines setting items associated with the low data size mode (e.g., items related to information on the color mode, resolution, contrast, sharpness, background color removal, and blank paper removal) for the items that affect the data size.

Examples of the conditions for changing to the “size saving scan mode” include the following case in addition to the case where the user intentionally sets the “maximum size of outgoing mail” in the mail setting to a small size. Examples of the conditions include a case where the transfer rate of the Internet is low during operation. These cases are examples of the related information related to the setting of job contents.

### Operation of Information Processing System

Next, the operation of the information processing system will be described.

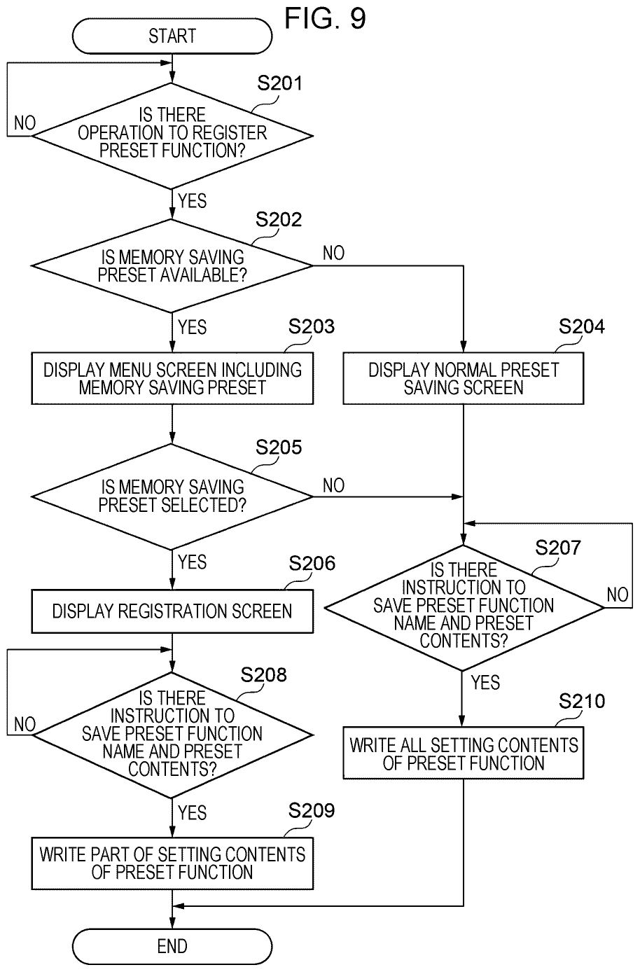

FIG. 9 is a flowchart illustrating a flow of a process of registering the preset function by the information processing apparatus 10 of the information processing system 1. The process of registering the preset function is performed by the CPU 11 reading the registration processing program from the ROM 12, loading the program into the RAM 13, and executing the program.

As illustrated in FIG. 9, the CPU 11 determines whether an operation to register the preset function is performed (step S201).

When the operation to register the preset function is performed (step S201: YES), the CPU 11 determines whether a memory saving preset is available (step S202). The CPU 11 determines whether the operation is being performed in each mode based on the setting of job contents. When the CPU 11 determines that the operation is being performed in any one of the modes, the CPU 11 determines that the memory saving preset is available. For example, when the CPU 11 determines that the operation is being performed in the consumables saving mode, the CPU 11 determines that the memory saving preset is available.

When the operation to register the preset function is not performed (step S201: NO), the CPU 11 waits until the operation to register the preset function is performed.

When the memory saving preset is available (step S202: YES), the CPU 11 displays a menu screen including the memory saving preset (step S203). For example, as illustrated in FIG. 3, the CPU 11 causes the display unit 16B to display the display screen 54 including the “consumables saving pinning” button 54A.

When the memory saving preset is not available (step S202: NO), the CPU 11 displays a normal preset saving screen (step S204). Illustration of the normal preset saving screen is omitted.

After the process of step S203, the CPU 11 determines whether the memory saving preset is selected (step S205). For example, when the “consumables saving pinning” button 54A on the display screen 54 is selected as illustrated in FIG. 3, the CPU 11 determines that the memory saving preset is selected.

When the memory saving preset is selected (step S205: YES), the CPU 11 displays a registration screen for the memory saving preset (step S206). For example, as illustrated in FIG. 3, the CPU 11 displays the display screen 56 for registering the memory saving preset.

When the memory saving preset is not selected (step S205: NO) or after the process of step S204 is performed, the CPU 11 determines whether an instruction is given to save a preset function name and preset contents (step S207). For example, the user can input a preset function name together with the preset contents. Illustration of the input screen is omitted.

After the process of step S206, the CPU 11 determines whether an instruction is given to save a preset function name and preset contents (step S208). For example, when the user inputs a preset function name (e.g., consumables saving copy) on the display screen 56 and presses the completion button 56A as illustrated in FIG. 3, the CPU 11 determines that the instruction is given to save the preset function name and the preset contents.

When the instruction is given to save the preset function name and the preset contents (step S208: YES), the CPU 11 writes a part of the setting contents of the preset function in the non-volatile memory 20 (step S209). For example, as illustrated in FIG. 4A, the CPU 11 does not write the settings that affect consumables in the non-volatile memory 20 as the preset for the consumables saving copy, but writes only the predetermined part of setting contents 72 in the non-volatile memory 20 as the preset information 70. For example, the pieces of information 814A and 814B on the settings that affect consumables in FIG. 4B are not written in the non-volatile memory 20. The preset information 70 includes the item 74 indicating that the consumables saving preset is applied.

When the instruction is not given to save the preset function name and the preset contents (step S208: NO), the CPU 11 waits until the instruction is given to save the preset function name and the preset contents.

When the instruction is given to save the preset contents (step S207: YES), the CPU 11 writes all the setting contents of the preset function in the non-volatile memory 20 (step S210).

When the instruction is not given to save the preset contents (step S207: NO), the CPU 11 waits until the instruction is given to save the preset contents. Thus, the process based on the registration processing program ends.

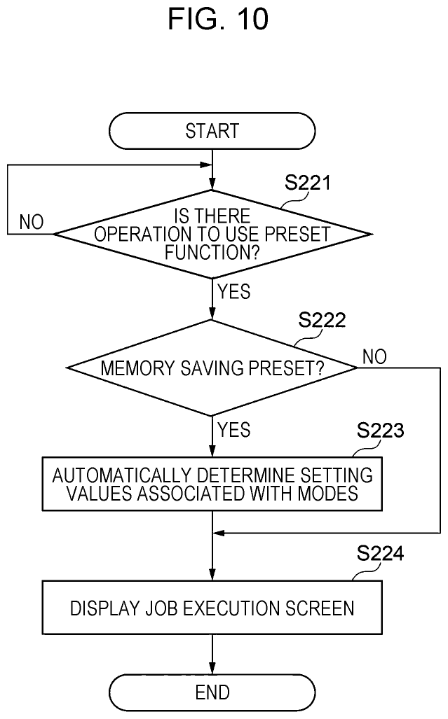

FIG. 10 is a flowchart illustrating a flow of a process of using the preset function by the information processing apparatus 10 of the information processing system 1. The process of using the preset function is performed by the CPU 11 reading a use processing program from the ROM 12, loading the program into the RAM 13, and executing the program.

As illustrated in FIG. 10, the CPU 11 determines whether an operation to use the preset function is performed (step S221).

When the operation to use the preset function is performed (step S221: YES), the CPU 11 determines whether the memory saving preset is to be used (step S222). For example, when the user selects the “consumables saving copy” button 59A on the display screen 58 as illustrated in FIG. 3, the CPU 11 determines that the consumables saving preset that is an example of the memory saving preset is to be used.

When the operation to use the preset function is not performed (step S221: NO), the CPU 11 waits until the operation to use the preset function is performed.

When the memory saving preset is to be used (step S222: YES), the CPU 11 automatically determines the setting values associated with the modes (step S223). For example, the CPU 11 acquires the mode information (e.g., the consumables saving mode, the high quality saving mode, or the low data size mode) and automatically determines the setting values associated with the modes. For example, when the mode is the consumables saving mode, as illustrated in FIG. 4A, the CPU 11 automatically determines the setting values associated with the consumables saving mode (e.g., the setting values for the color mode, nUP, density, and duplex printing) as the setting values that are not stored in the non-volatile memory 20. For the other setting values, the setting contents 72 of the consumables saving copy that are stored in the non-volatile memory 20 are used.

After the process of step S223, the CPU 11 displays a job execution screen (step S224). For example, as illustrated in FIG. 3, the display screen 60 for job execution is displayed.

When the memory saving preset is not to be used (step S222: NO), the CPU 11 displays the job execution screen (step S224). In this case, setting information of the preset that is stored in the non-volatile memory 20 is used. Thus, the process based on the use processing program ends.

In the information processing system 1, the CPU 11 stores, in the non-volatile memory 20, only a predetermined part of setting contents as preset information that is information on the preset function for presetting job contents. When the preset function is used, the CPU 11 automatically sets the setting contents other than the part of setting contents based on the related information related to the setting of the job contents.

Therefore, in the information processing system 1, the free space of the non-volatile memory 20 can be increased compared to the case where the non-volatile memory stores all pieces of information required to use the preset function for presetting the job contents. Thus, in the information processing system 1, the preset function can be provided to more people.

In the information processing system 1, the image forming apparatus 30 including the printing unit 31, the scanner 32, the facsimile 33, and the mail communication unit 34 is connected by wire or by wireless. Therefore, in the information processing system 1 having the configuration in which the image forming apparatus 30 is connected by wire or by wireless, the free space of the non-volatile memory 20 can be increased compared to the case where the non-volatile memory stores all pieces of information required to use the preset function for presetting the job contents.

In the information processing system 1, the other setting contents are settings that affect consumables. When the preset function is used, the CPU 11 automatically sets items that affect consumables based on related information related to consumables saving, without storing the settings that affect consumables in the non-volatile memory 20. Therefore, in the information processing system 1, the free space of the non-volatile memory 20 can be increased compared to the case where the non-volatile memory stores all pieces of information that affect consumables when the preset function is used.

In the information processing system 1, the other setting contents are settings that affect high image quality that is higher than normal image quality in terms of image quality of an image to be formed on a medium. When the preset function is used, the CPU 11 automatically sets items that affect high image quality based on related information related to image formation with high image quality, without storing the settings that affect high image quality in the non-volatile memory 20. Therefore, in the information processing system 1, the free space of the non-volatile memory 20 can be increased compared to the case where the non-volatile memory stores all pieces of information that affect high image quality when the preset function is used.

In the information processing system 1, the other setting contents are settings that affect reduction in data size. When the preset function is used, the CPU 11 automatically sets items that affect reduction in data size based on related information related to reduction in data size, without storing the settings that affect reduction in data size in the non-volatile memory 20. Therefore, in the information processing system 1, the free space of the non-volatile memory 20 can be increased compared to the case where the non-volatile memory stores all pieces of information that affect reduction in data size when the preset function is used.

In the information processing system 1, the CPU 11 stores a part of the related information in the non-volatile memory 20. Therefore, in the information processing system 1, the items are set more easily than in the case where the items are automatically set based only on related information that is unrelated to the contents stored in the non-volatile memory.

The information processing system 1 includes the display unit 16B that displays information and the input unit 16A that receives input of a user's instruction. When the preset function is to be registered and the storage capacity of the non-volatile memory 20 is savable based on mode information corresponding to the job contents, the CPU 11 causes the display unit 16B to display the registration portion for saving. When the user selects the registration portion, the CPU 11 stores only the part of setting contents as the preset information in the non-volatile memory 20. Therefore, in the information processing system 1, the preset information can be stored as intended by the user when the preset function is to be registered, compared to the case where only a part of setting contents is uniformly stored as the preset information in the non-volatile memory.

In the information processing system 1, when the storage capacity is not savable, the CPU 11 causes the display unit 16B not to display the registration portion for saving. Therefore, in the information processing system 1, the process is simplified compared to the case where the registration portion for saving is displayed on the display unit without determining whether the storage capacity of the non-volatile memory is savable.

In the information processing system 1, the CPU 11 automatically determines, for the other setting contents, setting items associated with the mode information when the preset function is used. Therefore, in the information processing system 1, the setting items are automatically determined more easily than in the case where the mode information on the job contents is not used.

### First Modification

Next, an information processing system according to a first modification will be described. The same components as those in the first exemplary embodiment described above are denoted by the same reference numerals, and description thereof will be omitted.

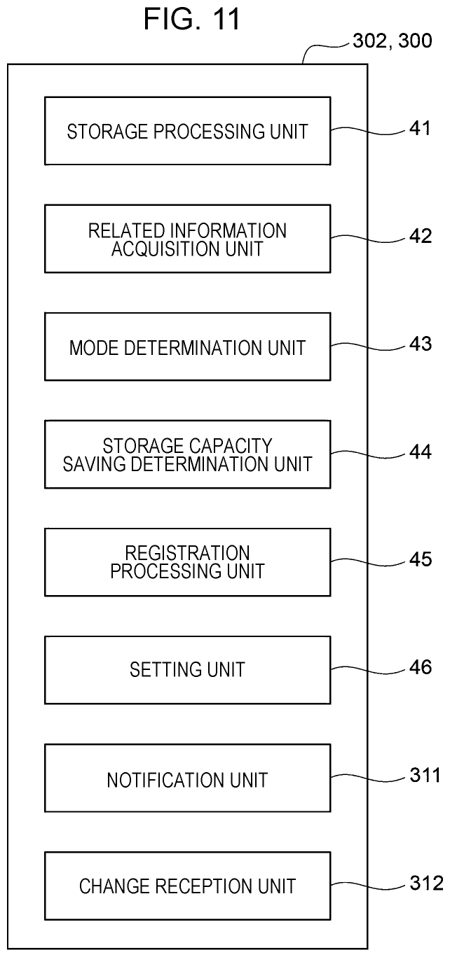

An information processing system 300 according to the first modification has a hardware configuration similar to that of the information processing system 1 according to the first exemplary embodiment illustrated in FIG. 1, but includes an information processing apparatus 302 instead of the information processing apparatus 10 illustrated in FIG. 1 (see FIG. 11). The information processing apparatus 302 has a hardware configuration similar to that of the information processing apparatus 10 illustrated in FIG. 1, but has a different functional configuration.

FIG. 11 is a block diagram illustrating an example of the functional configuration of the information processing apparatus 302 of the information processing system 300 according to the first modification.

As illustrated in FIG. 11, the information processing apparatus 302 includes, as functional components, the storage processing unit 41, the related information acquisition unit 42, the mode determination unit 43, the storage capacity saving determination unit 44, the registration processing unit 45, the setting unit 46, a notification unit 311, and a change reception unit 312. Each functional component is implemented by the CPU 11 reading the information processing program stored in the ROM 12, loading the program into the RAM 13, and executing the program.

The notification unit 311 notifies the user about items related to the other setting contents that are set automatically (setting contents other than the part of setting contents stored in the non-volatile memory 20). For example, the notification unit 311 notifies the user about the items related to the other setting contents by causing the display unit 16B to display information about the items.

The change reception unit 312 receives a user's change in the items related to the other setting contents. For example, when the user changes, through the input unit 16A, the items related to the other setting contents in the notification from the notification unit 311, the change reception unit 312 receives the change in the items related to the other setting contents. The items related to the other setting contents include, for example, items related to the settings that affect consumables, items related to the settings that affect high image quality, and items related to the settings that affect reduction in data size.

An information processing system according to a fourth comparative example will be described. When the preset function is used in the information processing system according to the fourth comparative example, settings that are not stored in the non-volatile memory are automatically made by the information processing apparatus.

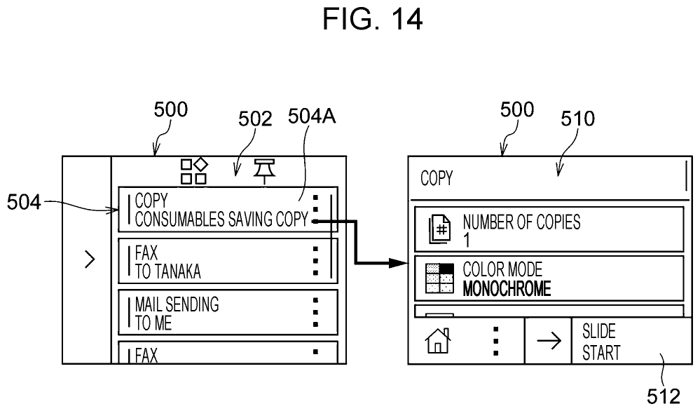

FIG. 14 illustrates an example of display screens of automatic setting for the consumables saving copy in the information processing system according to the fourth comparative example. As illustrated in FIG. 14, a plurality of processing menus 504 indicating job contents is displayed on a display screen 502 of a display unit 500. For example, when a copy button 504A in the processing menu 504 is selected, transition is made to a display screen 510 for giving an instruction to perform a copy operation. The user executes copy by, for example, sliding a start button 512 on the display screen 510.

In the information processing system according to the fourth comparative example, settings that are not stored in the non-volatile memory are automatically made by the information processing apparatus, and thus may be setting contents that are not intended by the user.

In the information processing system 300 according to the first modification, the CPU 11 of the information processing apparatus 302 notifies the user about items related to the other setting contents that are set automatically (setting contents other than the part of setting contents stored in the non-volatile memory 20). The CPU 11 of the information processing apparatus 302 receives a user's change in the items related to the other setting contents.

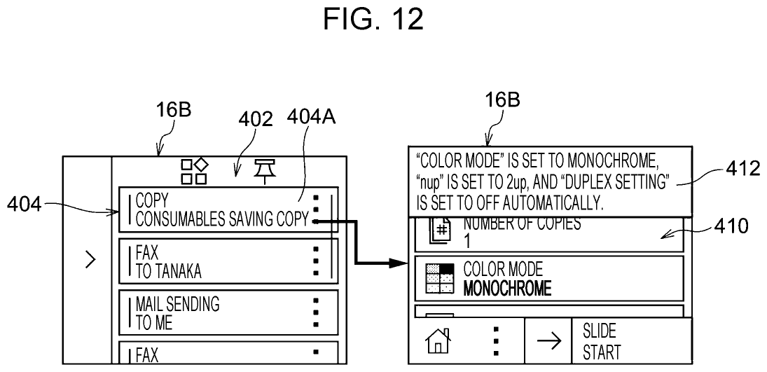

FIG. 12 illustrates an example of display screens of automatic setting for the consumables saving copy in the information processing system 300 according to the first modification. As illustrated in FIG. 12, a plurality of processing menus 404 indicating job contents is displayed on a display screen 402 of the display unit 16B. For example, when a “consumables saving copy” button 404A in the processing menu 404 is selected, transition is made to a display screen 410 for giving an instruction to perform a copy operation. At this time, information 412 about items related to the other setting contents that are set automatically is displayed for several seconds to overlap the display screen 410 of the display unit 16B.

That is, the CPU 11 of the information processing apparatus 302 notifies the user about the information 412 about the items related to the other setting contents that are set automatically by causing the display unit 16B to display the information 412 about the items related to the other setting contents.

Although illustration is omitted, in the information processing apparatus 302, the user can change contents related to the other setting contents to intended setting contents through the input unit 16A. For example, the CPU 11 of the information processing apparatus 302 receives the change in the items related to the other setting contents through the input unit 16A. The other configuration of the information processing system 300 according to the first modification is similar to that of the information processing system 1 according to the first exemplary embodiment.

In the information processing system 300 according to the first modification, the following operations and effects are obtained in addition to the operations and effects that are obtained with the configuration similar to that of the information processing system 1 according to the first exemplary embodiment.

In the information processing system 300, the CPU 11 of the information processing apparatus 302 notifies the user about items related to the other setting contents that are set automatically, and receives a user's change in the items related to the other setting contents. Therefore, in the information processing system 300, when the items related to the other setting contents that are set automatically are not intended by the user, the job can be executed while changing the items to items intended by the user.

In the information processing system 300, the CPU 11 of the information processing apparatus 302 notifies the user about the items related to the other setting contents by causing the display unit 16B to display the information 412 about the items related to the other setting contents, and receives the change in the items through the input unit 16A. Therefore, in the information processing system 300, the user more easily checks the information 412 about the items related to the other setting contents that are set automatically than in the case where the information about the items related to the other setting contents is not displayed.

### Second Modification

Next, an information processing system according to a second modification will be described. The same components as those in the first exemplary embodiment and the first modification described above are denoted by the same reference numerals, and description thereof will be omitted.

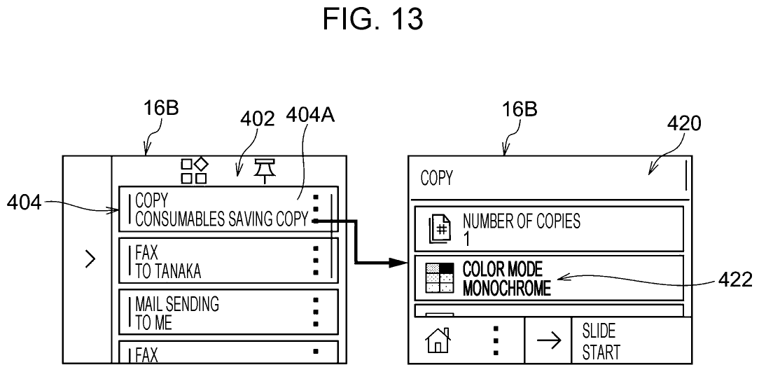

FIG. 13 illustrates an example of display screens of automatic setting for the consumables saving copy in the information processing system 300 according to the second modification. As illustrated in FIG. 13, the plurality of processing menus 404 indicating job contents is displayed on the display screen 402 of the display unit 16B. For example, when the “consumables saving copy” button 404A in the processing menu 404 is selected, transition is made to a display screen 420 for giving an instruction to perform a copy operation. On the display screen 420 of the display unit 16B, information 422 about items related to the other setting contents that are set automatically is displayed in boldface type or in a different color. The information 422 about the items related to the other setting contents that are set automatically indicates that the color mode is changed to monochrome. The information 422 about the items related to the other setting contents that are set automatically may be displayed in a shaded or highlighted pattern etc. as long as the information 422 is distinguishable from other information. When the user presses the button of the information 422, further details may be displayed about the items related to the other setting contents.

For example, the CPU 11 of the information processing apparatus 302 receives the change in the items related to the other setting contents through the input unit 16A. The other configuration of the information processing system 300 according to the second modification is similar to that of the information processing system 1 according to the first exemplary embodiment.

In the information processing system 300 according to the second modification, similar operations and effects are obtained with the configurations similar to those of the information processing system 1 according to the first exemplary embodiment and the information processing system 300 according to the first modification.

### Others

The information processing system according to the exemplary embodiment of the present disclosure is not limited to the information processing systems 1 and 300 according to the first exemplary embodiment, the first modification, and the second modification, and may be modified in various ways.

For example, in the first exemplary embodiment, the first modification, and the second modification, for the other setting contents, the setting items associated with the mode information are automatically determined when the preset function is used. However, the exemplary embodiment of the present disclosure is not limited to this configuration. For example, without using the mode information, the CPU 11 may automatically set the items based on related information related to the setting of the job contents.

While the exemplary embodiments of the present disclosure have been described in detail, it is to be understood that the exemplary embodiment of the disclosure is not limited to these exemplary embodiments, and various other exemplary embodiments may be conceivable by those skilled in the art without departing from the scope of the disclosure.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The exemplary embodiments of the present disclosure are also applicable to a program and a program product.

### APPENDIX

(((1))) According to an aspect of the present disclosure, there is provided an information processing system comprising a processor configured to: store, in a non-volatile storage unit, only a predetermined part of setting contents as preset information that is information on a preset function for presetting job contents; and when the preset function is used, automatically set other setting contents than the part of setting contents based on related information related to setting of the job contents.
(((2))) The information processing system according to (((1))), wherein the processor is configured to: notify a user about items related to the other setting contents that are set automatically; and receive a change in the items by the user.
(((3))) The information processing system according to (((2))), further comprising: a display unit configured to display information; and an input unit configured to receive input of an instruction from the user, wherein the processor is configured to: notify the user about the items related to the other setting contents by causing the display unit to display information about the items; and receive the change in the items through the input unit.
(((4))) The information processing system according to any one of (((1))) to (((3))), wherein an image forming apparatus is connected by wire or by wireless, the image forming apparatus comprising: an image forming unit configured to form an image on a medium; a reading unit configured to read a document; and a transmission unit configured to transmit information read by the reading unit.
(((5))) The information processing system according to any one of (((1))) to (((4))), wherein: the other setting contents are settings that affect consumables; and the processor is configured to, when the preset function is used, automatically set items that affect the consumables based on the related information related to saving of the consumables, without storing the settings that affect the consumables in the non-volatile storage unit.
(((6))) The information processing system according to any one of (((1))) to (((4))), wherein: the other setting contents are settings that affect high image quality that is higher than normal image quality in terms of image quality of an image to be formed on a medium; and the processor is configured to, when the preset function is used, automatically set items that affect the high image quality based on the related information related to image formation with the high image quality, without storing the settings that affect the high image quality in the non-volatile storage unit.
(((7))) The information processing system according to any one of (((1))) to (((4))), wherein: the other setting contents are settings that affect reduction in data size; and the processor is configured to, when the preset function is used, automatically set items that affect the reduction in data size based on the related information related to the reduction in data size, without storing the settings that affect the reduction in data size in the non-volatile storage unit.
(((8))) The information processing system according to any one of (((1))) to (((7))), wherein the processor is configured to store a part of the related information in the non-volatile storage unit.
(((9))) The information processing system according to any one of (((1))) to (((8))), further comprising: a display unit configured to display information; and an input unit configured to receive input of an instruction from a user, wherein the processor is configured to: when the preset function is to be registered and a storage capacity of the non-volatile storage unit is savable based on mode information corresponding to the job contents, cause the display unit to display a registration portion for saving; and when the user selects the registration portion, store only the part of setting contents as the preset information in the non-volatile storage unit.
(((10))) The information processing system according to (((9))), wherein the processor is configured to, when the storage capacity is not savable, cause the display unit not to display the registration portion for saving.
(((11))) The information processing system according to (((9))), wherein the processor is configured to automatically determine, for the other setting contents, setting items associated with the mode information when the preset function is used.
(((12))) A program causing a computer to execute a process for processing information, the process comprising: storing, in a non-volatile storage unit, only a predetermined part of setting contents as preset information that is information on a preset function for presetting job contents; and when the preset function is used, automatically setting other setting contents than the part of setting contents based on related information related to setting of the job contents.
(((13))) An information processing method comprising: storing, by a computer, in a non-volatile storage unit, only a predetermined part of setting contents as preset information that is information on a preset function for presetting job contents; and when the preset function is used, automatically setting, by the computer, other setting contents than the part of setting contents based on related information related to setting of the job contents.

What is claimed is:

1. An information processing system comprising:
a processor configured to:
store, in a non-volatile storage unit, only a predetermined part of setting contents as preset information that is information on a preset function for presetting job contents; and
when the preset function is used, automatically set other setting contents than the part of setting contents based on related information related to setting of the job contents.

2. The information processing system according to claim 1, wherein the processor is configured to:
notify a user about items related to the other setting contents that are set automatically; and
receive a change in the items by the user.

3. The information processing system according to claim 2, further comprising:
a display unit configured to display information; and
an input unit configured to receive input of an instruction from the user, wherein
the processor is configured to:
notify the user about the items related to the other setting contents by causing the display unit to display information about the items; and
receive the change in the items through the input unit.

4. The information processing system according to claim 1, wherein an image forming apparatus is connected by wire or by wireless, the image forming apparatus comprising:
an image forming unit configured to form an image on a medium;
a reading unit configured to read a document; and
a transmission unit configured to transmit information read by the reading unit.

5. The information processing system according to claim 1, wherein:
the other setting contents are settings that affect consumables; and
the processor is configured to,
when the preset function is used, automatically set items that affect the consumables based on the related information related to saving of the consumables, without storing the settings that affect the consumables in the non-volatile storage unit.

6. The information processing system according to claim 1, wherein:
the other setting contents are settings that affect high image quality that is higher than normal image quality in terms of image quality of an image to be formed on a medium; and
the processor is configured to,
when the preset function is used, automatically set items that affect the high image quality based on the related information related to image formation with the high image quality, without storing the settings that affect the high image quality in the non-volatile storage unit.

7. The information processing system according to claim 1, wherein:
the other setting contents are settings that affect reduction in data size; and
the processor is configured to,
when the preset function is used, automatically set items that affect the reduction in data size based on the related information related to the reduction in data size, without storing the settings that affect the reduction in data size in the non-volatile storage unit.

8. The information processing system according to claim 1, wherein the processor is configured to store a part of the related information in the non-volatile storage unit.

9. The information processing system according to claim 1, further comprising:
a display unit configured to display information; and
an input unit configured to receive input of an instruction from a user, wherein the processor is configured to:
when the preset function is to be registered and a storage capacity of the non-volatile storage unit is savable based on mode information corresponding to the job contents, cause the display unit to display a registration portion for saving; and
when the user selects the registration portion, store only the part of setting contents as the preset information in the non-volatile storage unit.

10. The information processing system according to claim 9, wherein the processor is configured to,
when the storage capacity is not savable, cause the display unit not to display the registration portion for saving.

11. The information processing system according to claim 9, wherein the processor is configured to:
automatically determine, for the other setting contents, setting items associated with the mode information when the preset function is used.

12. A non-transitory computer readable medium storing a program causing a computer to execute a process for processing information, the process comprising:
storing, in a non-volatile storage unit, only a predetermined part of setting contents as preset information that is information on a preset function for presetting job contents; and
when the preset function is used, automatically setting other setting contents than the part of setting contents based on related information related to setting of the job contents.

13. An information processing method comprising:
storing, by a computer, in a non-volatile storage unit, only a predetermined part of setting contents as preset information that is information on a preset function for presetting job contents; and
when the preset function is used, automatically setting, by the computer, other setting contents than the part of setting contents based on related information related to setting of the job contents.
